(19) United States
(12) Patent Application Publication
(10) Pub. No.: US 2015/0327707 A1
(43) Pub. Date: Nov. 19, 2015

(54) HEATING CONTAINER

(71) Applicant: HANSOL TECHNICS INC., Seoul (KR)

(72) Inventor: Su-Dong SON, Suwon-si (KR)

(21) Appl. No.: 14/701,840

(22) Filed: May 1, 2015

(30) Foreign Application Priority Data
May 14, 2014 (KR) 10-2014-0058006

(51) Int. Cl. A47J 27/00; H05B 6/04; H05B 6/12; A47J 36/24; H05B 6/06

(52) U.S. Cl. CPC A47J 27/004; A47J 36/2483; H05B 6/062; H05B 6/1218; H05B 6/04

(57) ABSTRACT

Provided is a heating container in which a space divided by a partition is provided on a bottom of a container unit formed of a nonmetallic material with high heat transfer efficiency such as ceramic and a heating unit which generates heat using an induction magnetic field generated using a wireless power consortium method is formed therein, a display unit which emits light due to heat generated by the heating unit or a display unit which changes emitted color depending on a change in a temperature of the heat generated by the heating unit is formed on the outside of the container unit, and a heating temperature of the container unit formed of nonmetallic material is sensed and the heating temperature of the heating unit is controlled through communication between a power transmission unit and a power receiving unit depending on the sensed heating temperature.

### CROSS-REFERENCE TO RELATED APPLICATION

This application claims priority under 35 U.S.C. §119 to Korean Patent Application No. 10-2014-0058006 filed on May 14, 2014, the disclosure of which is hereby incorporated by reference in its entirety.

### BACKGROUND

1. Field

Embodiments of the inventive concept relate to a heating container such as a cup and a bowl, and more particularly, to a heating container in which a space divided by a partition is provided on a bottom of a container unit formed of a nonmetallic material with high heat transfer efficiency such as ceramic and a heating unit which generates heat using an induction magnetic field generated using a wireless power consortium method is formed therein to allow the contents in the container unit such as water, coffee, and tea to be warm at all times while being drunken.

2. Description of Related Art

Generally, mobile electronic devices such as a cell phone, a personal digital assistant (PDA), an MP3, a digital multimedia broadcasting (DMB) device, and a camera all use a battery.

Accordingly, to charge a storage battery used in a mobile device, an additional charging device is necessary. Also, general charging systems are configured to step down prevailing voltage such as alternating current (AC) 110 to 220 V to rectify full waves and to allow output terminals of direct current (DC) voltage to be in contact with terminals of a battery to be charged.

However, in such a terminal supply method described above, when a charger and a battery is mutually coupled or separated from each other, since terminals of both sides have mutually different potential differences, an instant discharge phenomenon may occur. Also, foreign substances gradually accumulate on terminals to allow fire to occur. Also, due to humidity, the lives or performances of the charger and battery may become deteriorated such as being naturally discharged. Accordingly, non-contacting chargers in which when a terminal with a battery built therein which is to be charged is located above a primary coil, the battery is charged with electric power induced from an induced electromotive force caused by a secondary coil of the battery due to a magnetic field have been developed.

However, general non-contacting chargers described above only supply power to mobile terminals and there is no other use in such a way that there is a limitation on utility.

As related art, Korean Patent Publication No. 10-0564256 discloses “A wireless charging pad and a battery pack applied with a radiofrequency identification technology”, Korean Patent Publication No. 10-0603986 discloses “A wireless charging battery pack”, Korean Patent Publication No. 10-0751635 discloses “A concave pad of a wireless charger”, Korean Patent Publication No. 10-0971748 discloses “A short-range wireless power transmission system”, Korean Application Publication No. 10-2009-0098239 discloses “A wireless electric power transmission apparatus and a wireless charging system using the apparatus”, and Korean Application Publication No. 10-2006-0133756 discloses “A wireless charging apparatus and method of controlling the same”.

General cell phone charging systems charge batteries using power input through a plug when a cell phone is mounted on a charger, in which a range of use is determined according to a length of a wire between an electric outlet and the charger, an installation place thereof becomes complicated after installation due to the wire, and charging is not smoothly performed and a problem is caused by a contact failure when a contact point is abnormal.

Also, non-contacting charging systems using magnetic induction have a limitation in an inductive coupling distance between a transmitter and a receiver and a large volume.

Also, in general wireless charging systems, power is transferred while communication is being performed between a transmitter and a receiver and the receiver simply transfers the power to an electronic device such as a cell phone, a camera, and an MP3 player to charge a battery thereof.

That is, in businesses or homes, a container is used to drink water or a beverage or to eat soup. General containers are limited only to simply containing contents in such a way that although warm contents are put therein, a temperature of the contents drops after a certain amount of time.

Accordingly, in general, warm contents are put inside a thermos to drink or eat the contents. Also, when a temperature of contents in a container drops, the contents in the container are heated using a microwave oven to drink or eat. Otherwise, contents in a container are stored in an additional heating cabinet.

However, products described above such as microwave ovens and heating cabinets need to receive additional power and thus there are limitations in use. Thermoses maintain a temperature for a long time. However, temperature maintenance thereof becomes worse. Particularly, it is impossible to immediately raise a temperature of contents when to drink the contents.

### SUMMARY

Embodiments of the inventive concept provide a heating container in which a space divided by a partition is provided on a bottom of a container unit formed of a nonmetallic material with high heat transfer efficiency such as ceramic and a heating unit which generates heat using an induction magnetic field generated using a wireless power consortium method is formed therein to allow the contents in the container unit such as water, coffee, tea, and soup to be warm at all times while being drunken.

Other embodiments of the inventive concept provide a heating container in which a display unit which emits light due to heat generated by a heating unit or a display unit which changes emitted color depending on a change in a temperature of the heat generated by the heating unit is formed on the outside of a container unit, thereby not only increasing the aesthetic of the heating container but also allowing a user to check the heat generated by the heating unit to increase the convenience of the user and prevent accidents such as burns in advance.

Other embodiments of the inventive concept provide a heating container which senses a heating temperature of a container unit formed of a nonmetallic material and controls the heating temperature of a heating unit through communication between a power transmission unit and a power receiving unit depending on the sensed heating temperature, thereby increasing customer satisfaction while preventing accidents caused by heating.

The technical objectives of the inventive concept are not limited to the above disclosure; other objectives may become apparent to those of ordinary skill in the art based on the following descriptions.

In accordance with an aspect of the inventive concept, a heating container includes a container unit configured to be filled with contents to drink or eat and to be formed with an independent containing space divided by a partition on a bottom thereof, a heating plate configured to be contained in the containing space of the container unit to be closely attached to the partition and to perform heating through a magnetic field induced by a transmission coil of a power transmission unit which receives external power through a wireless power consortium (WPC) method to transfer heat to the container unit, a power receiving unit configured to be contained in the containing space of the container unit, to include a receiving coil which wirelessly receives voltages through the magnetic field induced by the transmission coil using the WPC method, and to control a heating temperature of the heating plate while controlling a strength of the magnetic field by adjusting an amount of the voltages wirelessly received through the receiving coil, and a cover unit configured to form a bottom surface of the containing space and to seal and waterproof the containing space.

In an embodiment, the power receiving unit may include a full bridge circuit configured to be connected to the receiving coil and to be driven to preliminarily rectify the voltages received from the receiving coil, a rectifier configured to be connected to the full bridge circuit and to secondarily rectify the voltages preliminarily rectified as the full bridge circuit is driven, an output section configured to output the voltages secondarily rectified by the rectifier, a power output microcontroller configured to receive the voltages output from the output section and the secondarily rectified voltages from the rectifier and to output a control signal for controlling the strength of the magnetic field induced by the transmission coil to control the heating temperature of the heating plate, and a communication driver configured to control the drive of the full bridge circuit to control the strength of the magnetic field induced by the transmission coil by adjusting the amount of voltages wirelessly received through the receiving coil according to the control signal output from the power output microcontroller.

In another embodiment, a temperature sensor connected to the power output microcontroller as a circuit may be formed in the containing space of the container unit.

In still another embodiment, in addition to the voltages output from the output section and the voltages secondarily rectified from the rectifier, the power output microcontroller may be mounted with a control program which controls the strength of the magnetic field induced by the transmission coil by controlling a voltage rectification value depending on the drive of the full bridge circuit through the communication driver to control the heating temperature of the heating plate according to the temperature of the container unit sensed by the temperature sensor.

In yet another embodiment, the container unit may include a display unit configured to be electrically connected to the power receiving unit to receive power therefrom and to display a heating operation state of the heating plate.

In yet another embodiment, the display unit may be a light emitting diode (LED) which emits light in a solid color depending on the heating temperature of the heating plate.

In yet another embodiment, the display unit may be an LED which varies in color of emitted light depending on changes in temperature according to the heating operation state of the heating plate.

### BRIEF DESCRIPTION OF THE DRAWINGS

The foregoing and other features and advantages of the inventive concepts will be apparent from the more particular description of preferred embodiments of the inventive concepts, as illustrated in the accompanying drawings in which like reference characters refer to the same parts throughout the different views. The drawings are not necessarily to scale, emphasis instead being placed upon illustrating the principles of the inventive concepts. In the drawings:

FIG. 1 is a perspective view of a heating container according to an embodiment of the inventive concept;

FIG. 2 is a perspective view illustrating a configuration of the partially-incised heating container according to the embodiment of the inventive concept;

FIG. 3 is a schematic cross-sectional view illustrating the configuration of the heating container according to the embodiment of the inventive concept;

FIG. 4 is a schematic block circuit diagram illustrating an electrical connection state of the heating container according to the embodiment of the inventive concept; and

FIG. 5 is a schematic block circuit diagram of a power receiving unit according to the embodiment of the inventive concept.

### DETAILED DESCRIPTION OF THE EMBODIMENTS

Hereinafter, embodiments of the present invention will be described in detail with reference to the attached drawings.

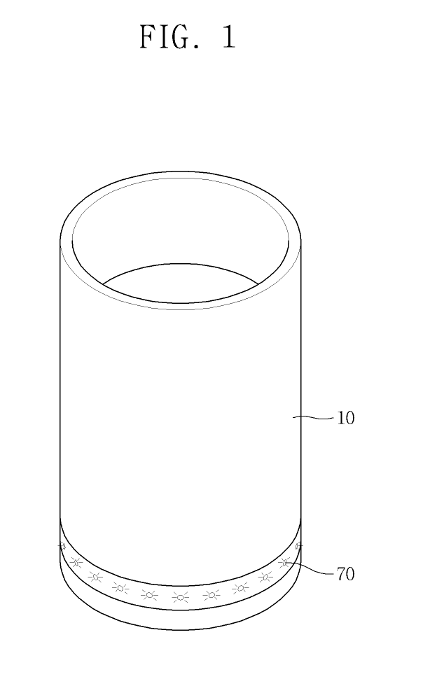

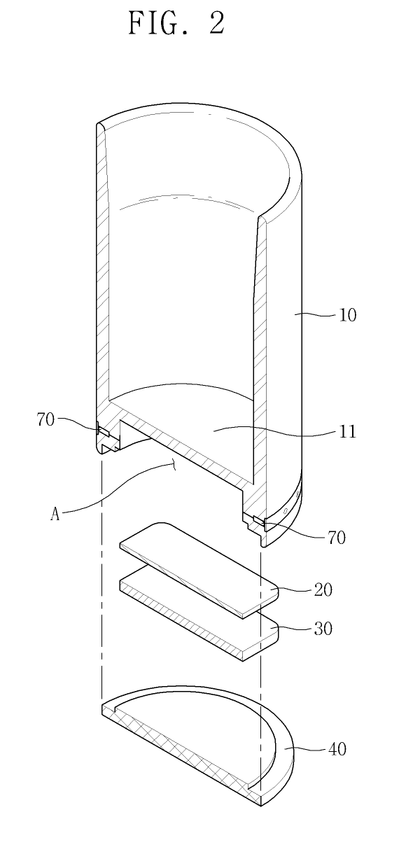

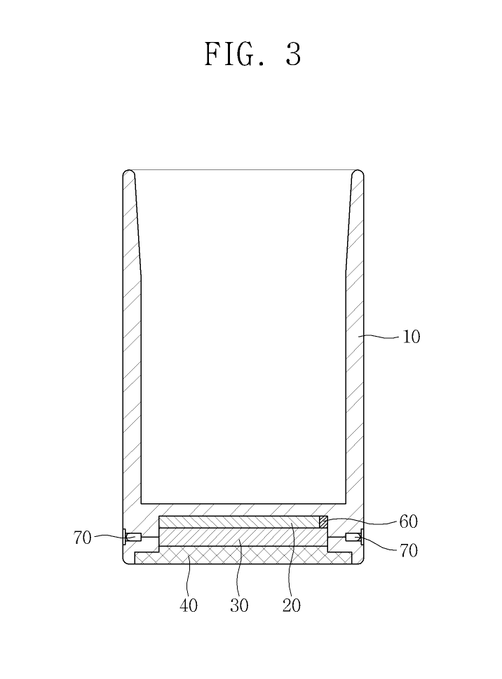

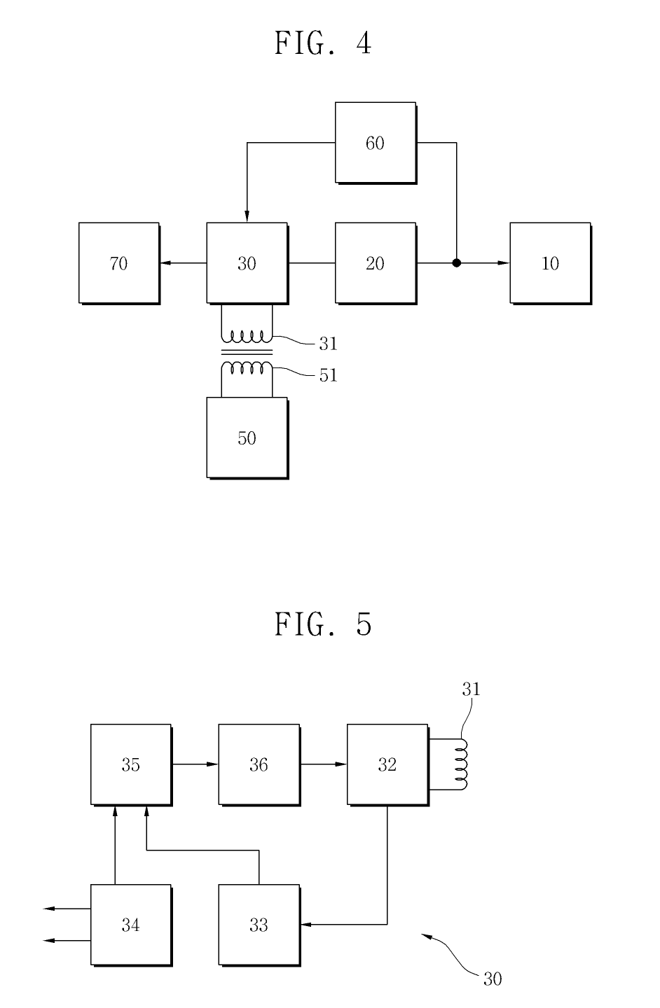

FIG. 1 is a perspective view of a heating container according to an embodiment of the inventive concept. FIG. 2 is a perspective view illustrating a configuration of the partially-incised heating container according to the embodiment of the inventive concept. FIG. 3 is a schematic cross-sectional view illustrating the configuration of the heating container according to the embodiment of the inventive concept. FIG. 4 is a schematic block circuit diagram illustrating an electrical connection state of the heating container according to the embodiment of the inventive concept. FIG. 5 is a schematic block circuit diagram of a power receiving unit according to the embodiment of the inventive concept.

Referring to FIGS. 1 to 5, the heating container according to the embodiment of the inventive concept includes a container unit 10, a heating plate 20, a power receiving unit 30, and a cover unit 40, and further includes a temperature sensor 60 and a display unit 70.

The container unit 10 is formed of ceramic which is a nonmetallic material and filled with contents to drink or eat. An independent containing space A divided by a partition 11 is formed on a bottom of the container unit 10.

The heating plate 20 is a metallic material, contained in the containing space A of the container unit 10, and closely attached to the partition 11. The heating plate 20 is configured to be heated by a magnetic field induced by a transmission coil 51 of a power transmission unit 50 which receives external power to transmit heat to the container unit 10 through a wireless power consortium (WPC) method.

The power receiving unit 30 is configured to be contained in the containing space A of the container unit 10, to include a receiving coil 31 which wirelessly receives voltages through the magnetic field induced by the transmission coil 51 through the WPC method, and to control a strength of the magnetic field by controlling an amount of the voltages wirelessly received through the receiving coil 31 to control a heating temperature of the heating plate 20.

Here, the power receiving unit 30 further includes a full bridge circuit 32, a rectifier 33, an output section 34, a power output microcontroller 35, and a communication driver 36, in addition to the receiving coil 31.

The full bridge circuit 32 is connected to the receiving coil 31 and is driven to preliminarily rectify the voltages received from the receiving coil 31.

The rectifier 33 is configured to be connected to the full bridge circuit 32, to secondarily rectify the preliminarily rectified voltages according to the drive of the full bridge circuit 32, and to output the secondarily rectified voltages to the power output microcontroller 35 and the output section 34.

The output section 34 is configured to output the voltages secondarily rectified and output by the rectifier 33 to the power output microcontroller 35.

The power output microcontroller 35 receives the secondarily rectified voltages from the rectifier 33 and output voltages of the output section 34 and outputs a control signal to control the strength of the magnetic field induced by the transmission coil 51, which is to control the heating temperature of the heating plate 20.

The communication driver 36 is configured to control the strength of the magnetic field induced by the transmission coil 51 by controlling the amount of voltages wirelessly received by the receiving coil 31 according to the control signal output from the power output microcontroller 35. For this, the communication driver 36 is configured to control the drive of the full bridge circuit 32.

Here, the full bridge circuit 32, the rectifier 33, the output section 34, the power output microcontroller 35, and the communication driver 36 are contained in the containing space A provided on the bottom of the container unit 10 while being mounted on a substrate.

The cover unit 40 is configured to form a bottom surface of the containing space A to seal and waterproof the containing space A.

The temperature sensor 60 is configured to be contained in the containing space A of the container unit 10, to be electrically connected to the power output microcontroller 35 mounted on the substrate, and to sense and output a surface temperature of the container unit 10 according to the heating of the heating plate 20 to the power output microcontroller 35.

Here, in addition to the voltages output from the output section 34 and the voltages secondarily rectified by the rectifier 33, the power output microcontroller 35 is configured to include a control program which controls the strength of the magnetic field induced by the transmission coil 51 by controlling a voltage rectification value depending on the drive of the full bridge circuit 32 through the communication driver 36 to control the heating temperature of the heating plate 20 according to the temperature of the container unit 10 sensed by the temperature sensor 60.

The display unit 70 emits light outside the container unit 10, displays a heating operation state of the heating plate 20 while being electrically connected to the power receiving unit 30 and receiving power therefrom. The display unit 70 is a light emitting diode (LED) which displays the operation state of the heating plate 20 according to the heating temperature thereof as a solid color or an LED which varies in color of emitted light with changes in temperature depending on the heating operation state of the heating plate 20.

As described above, in the case of the heating container, as shown in FIGS. 1 to 5, while contents such as water and beverages are being in the container unit 10 formed of ceramic which is a nonmetallic material, when to drink warm contents, the container unit 10 is disposed on the power transmission unit 50 which receives external power.

Then, the transmission coil 51 of the power transmission unit 50 induces a magnetic field through the WPC method, the receiving coil 31 of the power receiving unit 30 formed in the containing space A on the bottom of the container unit 10 receives voltages through the induced magnetic field, and the full bridge circuit 32 included in the power receiving unit 30 is driven to preliminarily rectify and output the voltages to the rectifier 33 when receiving the voltages from the receiving coil 31.

Here, the rectifier 33 secondarily rectifies the voltages preliminarily rectified according to the drive of the full bridge circuit 32 and outputs the secondarily rectified voltages to the output section 34 and the power output microcontroller 35 in such a way that the power output microcontroller 35 receives the secondarily rectified voltages from the output section 34 and the rectifier 33, respectively, and then outputs a control signal for controlling the strength of the magnetic field induced by the transmission coil 51 to the communication driver 36.

Then, the communication driver 36 controls the drive of the full bridge circuit 32 to control an amount of the voltages wirelessly received through the receiving coil 31 according to the control signal output from the power output microcontroller 35, thereby controlling the amount of the voltages received through the receiving coil 31 through the controlling the drive of the full bridge circuit 32.

Since the strength of the magnetic field induced by the transmission coil 51 is controlled through the control of the amount of the voltages at the receiving coil 31, the heating of the heating plate 20 caused by the magnetic field is determined, and heat generated by the heating of the heating plate 20 is transferred to the container unit 10 to heat the container unit 10 to increase a temperature of the container unit 10, thereby warming the contents inside the container unit 10 to a certain temperature or maintaining a certain warm temperature of the contents.

Meanwhile, the temperature sensor 60 provided in the containing space A of the container unit 10 senses a surface temperature of the container unit 10 according to the heating of the heating plate 20 and outputs the sensed surface temperature to the power output microcontroller 35.

The power output microcontroller 35 receives feedback on the secondarily rectified voltages from the rectifier 33 and a voltage output value of the output section 34. In addition, the power output microcontroller 35 outputs a control signal to the communication driver 36 depending on the temperature sensed by the temperature sensor 60 and the communication driver 36 controls the drive of the full bridge circuit 32.

Then, the strength of the magnetic field induced by the transmission coil 51 may be adjusted as a voltage rectification value according to the drive of the full bridge circuit 32 is being controlled.

That is, when the temperature sensed by the temperature sensor 60 is too high or too low, the power output microcontroller 35 adjusts the strength of the magnetic field induced by the transmission coil 51 to be lower or higher by controlling the voltage rectification value according to the drive of the full bridge circuit 32 through the communication driver 36 depending on the temperature of the container unit 10 sensed by the temperature sensor 60. Depending on the strength of the magnetic field which varies, the heating temperature of the heating plate 20 may decrease or increase and the temperature of the container unit 10 may become decreased or increased according thereto.

Here, since the container unit 10 includes the display unit 70 formed of an LED, the display unit 70 emits light in a solid color depending on a heating operation state of the heating plate 20 or varies in color of emitted light according to changes in temperature caused by the heating operation state of the heating plate 20, thereby allowing the user to easily check a heating state of the container unit 10 according to the heating of the heating plate 20 from the outside.

Here, the color of emitted light, for example, may be yellow when a temperature according to the heating of the heating plate 20 is lower than a reference temperature value, may be green when the temperature according to the heating of the heating plate 20 is the reference temperature value, and may be red when the temperature according to the heating of the heating plate 20 is higher than the reference temperature value but is not limited thereto and may change into other colors.

Here, interconnecting the color of emitted light of the LED with the changes in temperature according to the heating of the heating plate 20 is to prevent accidents such as burns by easily checking the heating temperature of the container unit 10 from the outside and to provide an aesthetic exterior of the heating container.

According to the embodiment of the present invention, there is provided a heating container in which a space divided by a partition is provided on a bottom of a container unit formed of a nonmetallic material with high heat transfer efficiency such as ceramic and a heating unit which generates heat using an induction magnetic field generated using a wireless power consortium method is formed therein, a display unit which emits light due to heat generated by the heating unit or a display unit which changes emitted color depending on a change in a temperature of the heat generated by the heating unit is formed on the outside of the container unit, and a heating temperature of the container unit formed of a nonmetallic material is sensed and the heating temperature of the heating unit is controlled through communication between a power transmission unit and a power receiving unit depending on the sensed heating temperature, thereby allowing the contents in the container unit such as water, coffee, tea, and soup to be warm at all times while being drunken, not only increasing the aesthetic of the heating container but also allowing a user to check the heat generated by the heating unit to increase the convenience of the user and increase customer satisfaction while particularly preventing accidents such as burns in advance.

As described above, technical features of a heating container has been described with reference to the attached drawings, which are merely exemplary embodiments of the present invention but not limit the present invention.

Therefore, it is to be understood that the foregoing is illustrative of various embodiments and is not to be construed as limited to the specific embodiments disclosed, and that modifications to the disclosed embodiments, as well as other embodiments, are intended to be included within the scope of the appended claims.

What is claimed is:

1. A heating container comprising:
a container unit configured to be filled with contents to drink or eat and to be formed with an independent containing space divided by a partition on a bottom thereof;
a heating plate configured to be contained in the containing space of the container unit to be closely attached to the partition and to perform heating through a magnetic field induced by a transmission coil of a power transmission unit which receives external power through a wireless power consortium method to transfer heat to the container unit;
a power receiving unit configured to be contained in the containing space of the container unit, to comprise a receiving coil which wirelessly receives voltages through the magnetic field induced by the transmission coil using the wireless power consortium method, and to control a heating temperature of the heating plate while controlling a strength of the magnetic field by adjusting an amount of the voltages wirelessly received through the receiving coil; and
a cover unit configured to form a bottom surface of the containing space and to seal and waterproof the containing space.

2. The heating container of claim 1, wherein the power receiving unit comprises:
a full bridge circuit configured to be connected to the receiving coil and to be driven to preliminarily rectify the voltages received from the receiving coil;
a rectifier configured to be connected to the full bridge circuit and to secondarily rectify the voltages preliminarily rectified as the full bridge circuit is driven;
an output section configured to output the voltages secondarily rectified by the rectifier;
a power output microcontroller configured to receive the voltages output from the output section and the secondarily rectified voltages from the rectifier and to output a control signal for controlling the strength of the magnetic field induced by the transmission coil to control the heating temperature of the heating plate; and
a communication driver configured to control the drive of the full bridge circuit to control the strength of the magnetic field induced by the transmission coil by adjusting the amount of voltages wirelessly received through the receiving coil according to the control signal output from the power output microcontroller.

3. The heating container of claim 2, wherein a temperature sensor connected to the power output microcontroller as a circuit is formed in the containing space of the container unit.

4. The heating container of claim 3, wherein in addition to the voltages output from the output section and the voltages secondarily rectified from the rectifier, the power output microcontroller is mounted with a control program which controls the strength of the magnetic field induced by the transmission coil by controlling a voltage rectification value depending on the drive of the full bridge circuit through the communication driver to control the heating temperature of the heating plate according to the temperature of the container unit sensed by the temperature sensor.

5. The heating container of claim 1, wherein the container unit comprises a display unit configured to be electrically connected to the power receiving unit to receive power therefrom and to display a heating operation state of the heating plate.

6. The heating container of claim 5, wherein the display unit is one of a light emitting diode (LED) which emits light in a solid color depending on the heating temperature of the heating plate and an LED which varies in color of emitted light depending on changes in temperature according to the heating operation state of the heating plate.
